(19) United States
(12) Patent Application Publication
(10) Pub. No.: US 2016/0176150 A1
(43) Pub. Date: Jun. 23, 2016

(54) MASKING OPTIMIZATION SYSTEM AND METHOD

(71) Applicant: PDS IG Holding LLC, Prairie Du Sac, WI (US)

(72) Inventor: Paul Trpkovski, Green Cove Springs, FL (US)

(21) Appl. No.: 14/973,229

(22) Filed: Dec. 17, 2015

Related U.S. Application Data
(60) Provisional application No. 62/094,491, filed on Dec. 19, 2014.

(51) Int. Cl. B32B 3/14; B32B 17/06; B32B 37/14

(52) U.S. Cl. CPC B32B 3/14; B32B 37/14; B32B 17/06; B32B 2419/00; B32B 2307/412

(57) ABSTRACT

A method and system for masking a planar substrate are described, along with a masked planar substrate, where a masking material includes at least two different pieces having different widths.

### CLAIM OF PRIORITY

This application claims the benefit of U.S. Provisional Application No. 62/094,491, filed Dec. 19, 2014, the content of which is herein incorporated by reference in its entirety.

### FIELD OF THE TECHNOLOGY

This application relates to systems and methods for masking a planar substrate, such as a glass unit. More specifically, the present application relates to optimizing the application of masking material to a glass pane.

### BACKGROUND

Nearly all buildings and homes have windows. Windows typically include at least one fragile glass pane disposed within a frame. It is frequently desired that the windows are clear and easy to see through; therefore the glass is normally desired to be free of scratches, cracks or chips. The assembly of the frame around the glass can subject the glass to being damaged. Similarly, transportation and installation of the window can subject the glass to being damaged.

Window manufacturers commonly apply a coating, often referred to as a mask or masking material, to protect a glass pane from these and other types of damage. The masking material can then be removed at some later time, such as after the window is installed.

While the use of a masking material to protect windows is not new, there remains a desire for new and/or improved machines and methods for applying a masking material to a glass pane. Improvements to glass masking systems and processes could also be useful for masking other types of products.

### SUMMARY

One general aspect includes a method of masking a glass pane, including: locating a planar substrate. The method also includes applying a first piece of masking material to a first surface of the planar substrate. The method also includes applying a second piece of masking material to the first surface of the planar substrate, where the first piece of masking material has a first width and the second piece of masking material has a second width different than the first width. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a masked planar substrate, including: a planar substrate having a surface including an inner mask region and a perimeter nonmask region surrounding the mask region. The masked planar substrate also includes a mask covering the mask region of the surface but not the nonmask region of the surface, the mask including a plurality of pieces of a masking material, including a first piece of masking material having a first width and a second piece of masking material having a second width different than the first width.

One general aspect includes a system for masking a glass unit, including: a workstation configured to support a planar substrate having a first surface. The system also includes a first roll of masking material having a first width. The system also includes a second roll of masking material having a second width different than the first width. The system also includes a movement mechanism configured to move the first roll and the second roll relative to the planar substrate. The system also includes an applicator configured to apply pieces of masking material from the first roll and pieces of masking material from the second roll to the surface of the planar substrate.

### BRIEF DESCRIPTION OF THE DRAWINGS

The following drawings illustrate some particular embodiments of the present invention and therefore do not limit the scope of the invention. The drawings are not to scale (unless so stated) and are intended for use with the explanations in the following detailed description. Some embodiments will hereinafter be described in conjunction with the appended drawings, wherein like numerals denote like elements.

FIG. 1 is a perspective schematic view of a pane positioned at a masking workstation according to an embodiment.

FIG. 2 is a plan view of a pane having a mask region according to an embodiment.

FIGS. 3A and 3B are plan and side schematic views, respectively, of masking material applied to the pane in FIG. 2 according to an embodiment.

FIGS. 4A and 4B are plan and side schematic views, respectively, of additional masking material applied to the pane in FIGS. 3A and 3B according to an embodiment.

FIG. 5 is a side schematic view of masking material applied to a pane according to an embodiment.

FIG. 6 is a side schematic view of masking material applied to a pane according to an embodiment.

FIG. 7 is a side schematic view of masking material applied to a pane according to an embodiment.

FIG. 8 is a flow diagram illustrating a method of masking glass pane according to an embodiment.

### DETAILED DESCRIPTION

The following detailed description is exemplary in nature and is not intended to limit the scope, applicability, or configuration of the invention in any way. Rather, the following description provides some practical illustrations for implementing some embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

Many details related the processes and systems described herein are not described as they are known to those of ordinary skill in the art. Examples of these types of details include methods and structures for moving and handling glass panes and glass units, including webs, rollers, actuators and conveyors. Further examples of these types of details include methods and structures for applying masking material to a glass pane, and methods and structures for handling and moving tools, rolls of masking material and other items.

One aspect relates to masking or covering at least a portion of a workpiece with a masking material. In some cases, the workpiece has a generally planar surface. For example, in some embodiments a masking material is applied to a workpiece that is a generally planar substrate with two substantially planar surfaces. One example of a planar substrate workpiece is a glass pane. Another workpiece example is a glass unit that is formed from two or more glass panes.

Some embodiments that will be described in greater detail are embodiments directed to glass panes and glass units. The usefulness of the concepts illustrated herein is not limited to glass panes and glass units, though. Instead, embodiments of the invention can involve the masking of other types of objects and materials, such as, for example, mirrors and polymeric substrates. Accordingly, while this disclosure provides some examples of systems and methods for applying a masking material to glass panes and glass units, it should be appreciated that use of the terms “glass pane” and “glass unit” is not meant to limit the applicability of the invention to other types of substrates. Instead, examples of systems and methods described herein in terms of glass panes and glass units are understood to be generally applicable to other types of planar substrates that could be masked.

Some embodiments relate to masking of a non-planar workpiece. Some embodiments relate to masking of a workpiece that is generally oriented in a plane but does not have a flat surface.

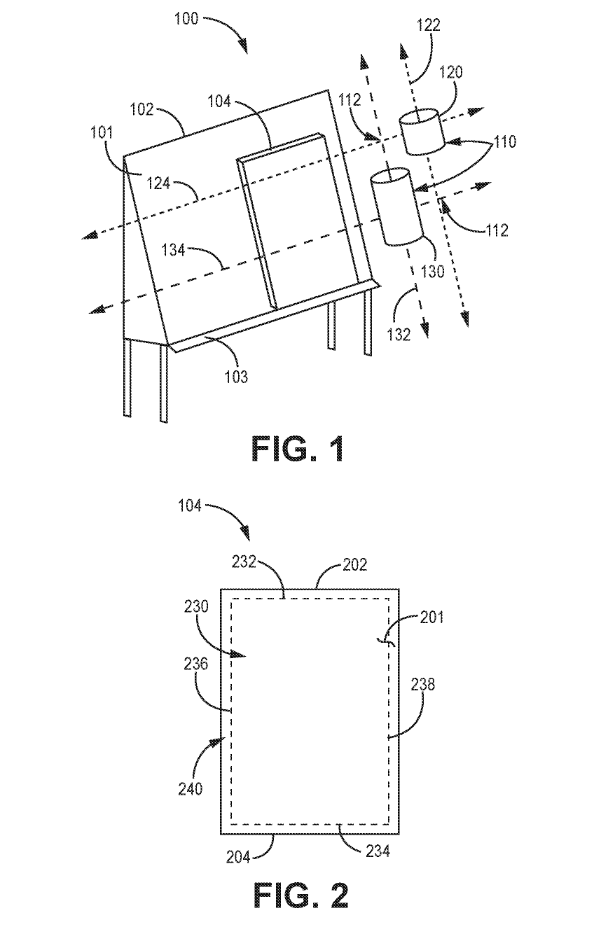

FIG. 1 is a perspective, schematic view of a masking station 100 according to some embodiments of the invention. The masking station 100 includes a workstation 102 that is configured to support a glass pane 104. The workstation 102 includes a planar surface 101 and a shelf 103 for supporting the glass pane 104. The masking station 100 also includes a masking applicator 110 that is schematically represented by a first roll 120 of masking material and a second roll 130 of masking material. The masking station 100 also includes a movement mechanism 112, which is represented by axes of movement 122, 124, 132, and 134. In this embodiment, the movement mechanism 112 is configured to move the first and second masking rolls 120, 130 relative to the workstation 102 and glass pane 104, while the applicator 110 is configured to apply the masking material from one or both rolls to the pane.

In an embodiment, the masking material can include a substrate and an adhesive, such as to result in an adhesive side and a non-adhesive side. In an embodiment, the masking material can include a first surface and a second surface, such as when the masking material is a sheet. An adhesive can be disposed on the second surface. The first surface can contact the roller when the masking material is on the roller. The second surface can contact the glass unit when the masking material is applied to the glass unit. In an embodiment, the masking material can include a polymer, such as a transparent or translucent polymer.

As shown in FIG. 1, in some embodiments, the workstation 100 includes a planar support surface configured to receive the pane 104. The workstation 100 also includes a shelf extending from the bottom of the support surface that helps maintain the pane 104 in position upon the support surface.

In this embodiment the workstation 100 is constructed with the support surface reclining from a vertical axis. In some cases the support surface may have a tilt of about six degrees from a vertical axis. Of course the workstation's support surface could be tilted at any one of a number of other useful angles. For example, in some cases the support surface may be configured so as to be horizontal (i.e., 90° from the vertical), nearly vertical, or at any other angle there between. Other types of workpieces and objects could also be supported by the workstation 100 or a modified version of the workstation 100 and could thus also be masked according to the concepts disclosed herein.

As shown in FIG. 1, in some embodiments the movement mechanism 112 is configured to move the masking rolls 120, 130 along orthogonal axes with respect to the glass pane 104 and the workstation 102. For example, in this embodiment the movement mechanism 112 is configured to move the first masking roll 120 along a first axis 112 that is generally parallel to the glass pane 104 and the support surface of the workstation 102. The movement mechanism 112 is further configured to move the first roll 120 along a second axis 124 that is orthogonal to the first axis 122 and generally horizontal as depicted in FIG. 1. Likewise, the movement mechanism 112 is configured to move the second roll 130 of masking material along orthogonal axes 132, 134.

The masking applicator 110 is further configured to apply pieces of the masking material from the masking rolls 120, 130 to the glass pane. In some embodiments, the movement mechanism moves the rolls 120, 130 along the generally horizontal axes 124, 134 and across the surface of the pane 104 as the applicator 110 applies pieces of the masking material from the masking rolls. In some embodiments, the rolls 120, 130 are stationary in a horizontal position while the masking applicator 110 pulls on a piece of masking material in a horizontal direction to unwind it from one of the rolls 120, 130 and apply it to the glass pane. In either of these types of embodiments, the generally vertical movement of the masking rolls along axes 122, 132 allows the applicator 110 to apply pieces of masking material from the first and second masking rolls at various vertical positions on the pane 104 as shown in FIG. 1.

According to some embodiments, the masking material on each of the first and second rolls 120, 130 can be applied to the surface of the pane 104 using one of many different devices or techniques. The masking material applicator 110 could have, for example, a vacuum roller associated with each masking roll that retains pieces or strips of the masking material with a negative pressure and then releases the piece of masking material onto the surface of the pane 104. In some cases a static charge may keep a piece of masking material upon a roller instead of a vacuum.

Other types of known applicators can also be used as may be desirable. As just some examples, a masking applicator may include a masking head for each roll of masking material. A strip of masking material from a roll can be fed to the masking head for applying to the pane. In some cases the movement mechanism may move the masking heads while the masking rolls remain stationary. According to some embodiments, each masking roll is mounted near and moves with its masking head on the movement mechanism so that a smaller length of masking material is exposed between the masking head and the roll. Further, in some embodiments it is contemplated that a movement mechanism may keep the masking rolls and masking heads at a fixed point and that the movement mechanism may further move the pane 104 and/or the workstation back and forth with respect to the applicator 110 and the masking rolls 120, 130.

FIG. 2 is a front or plan view of the glass pane 104. In some cases the glass pane 104 may be part of an insulating glass unit (IGU). In general, the glass pane 104 has a surface 201 and four edges, including a top edge 202, a bottom edge 204, and two side edges. The terms top, bottom, side, left, right, vertical, horizontal, and other such directional indicators, are used within this disclosure to more conveniently refer to various parts of the embodiments as those embodiments are depicted in the figures. It should be appreciated, though, that such terms do not necessarily describe inherent properties of the embodiments unless disclosed as such, and thus the use of such directional guides does not limit the scope of possible embodiments according to the invention.

Returning to FIG. 2, this example also depicts the glass pane 104 as having a central mask region 230 and a perimeter nonmask region 240 that surrounds the mask region 230. In this embodiment the mask region 230 extends across the surface 201 of the pane 104 between a first edge 232 and a second edge 234. The mask region 230 also extends across the surface 201 between a third edge 236 and a fourth edge 238. In this embodiment the mask region 230 has a generally rectangular configuration defined by its four edges, though that is not required in all embodiments. In this embodiment, the nonmask region 240 has the configuration of a generally uniform border or perimeter region extending between the mask region 230 and the edges of the pane 104.

In various embodiments, the mask region 230 covers the entire surface of the glass pane, and there is no perimeter nonmask region.

As shown in FIG. 1, the masking workstation 100 is configured to apply pieces of masking material from both the first masking roll 120 and the second masking roll 130 to the masking region 230 of the pane. According to some embodiments of the invention, the masking workstation 100 is part of a system for masking a glass pane and/or a glass unit with pieces of masking material having different widths. As used herein, the term “length” is used to refer to a dimension extending along the masking material as it is wound around the masking rolls 120, 130 as shown in the drawings. The term “width” is used to refer to the dimension of the masking material that is generally perpendicular to the length and, at least in the illustrated examples, shorter than the length. In some embodiments the length of a masking material piece that is stored on a roll is significantly larger than the width of that masking material piece, such as 10 times larger, 100 times larger or 1000 times larger. Of course it should be understood that the terms length and width can be used to refer to various dimensions and thus the use of these terms herein is not meant to limit the scope of possible embodiments of the invention.

Referring again to FIG. 1, in this example the first masking roll 120 has a first width defined along the roll's axis of rotation. Similarly, the second masking roll 130 has a second width defined along its axis of rotation. In some embodiments, such as the embodiment illustrated in FIG. 1, the first width of the first masking roll is different than the second width of the second masking roll 130. In some embodiments, such as the embodiment illustrated in FIG. 1, the first width of the first masking roll is smaller than the second width of the second masking roll 130.

In the embodiment of FIG. 1, the first masking roll 120 will be moved relative to the glass pane 104 in a direction of movement 124 as the masking material is applied. In the embodiment of FIG. 1, the second masking roll 130 will be moved relative to the glass pane 104 in a direction of movement 134 as the masking material is applied. In the embodiment of FIG. 1, the direction of movement 124,134 for each of the rolls 120, 130 is perpendicular to the axis of rotation of each of the rolls 120, 130. So the rolls 120, 130 are each moved in a direction 124, 134 that causes unwinding of the masking material if an end of the masking material is fixed.

According to some embodiments, and as will be explained further herein, the masking system/workstation 100 is configured to apply to the pane 104 one or more pieces of masking material having the first width and one or more pieces of masking material having the second width. In the depicted embodiments, the pieces of masking material are generally configured as strips that extend horizontally across the pane 104 as the pane is oriented on the workstation 102. In general, the masking system 100 covers the mask region 230 by applying a combination of one or more pieces of masking material from each masking roll 120, 130.

According to some embodiments, the masking system 100 is configured to optimize the number of masking pieces from each roll in order to minimize an amount of waste masking material. For example, a method of masking the pane 104 with the masking station 100 may involve applying one or more pieces of masking material from each roll 120, 130 to cover all, or nearly all, of the masking region 230. In some cases, an extending portion of one of the masking pieces may extend outside the mask region 230. Such portions of masking material must be removed in some cases so that the masking material does not cover any portion of the nonmask region 240. Typically, such portions of masking material are waste and usually discarded. Thus, while tools and methods are available to remove waste masking material, it is still desirable to reduce the amount of masking material that extends outside the masking region 230.

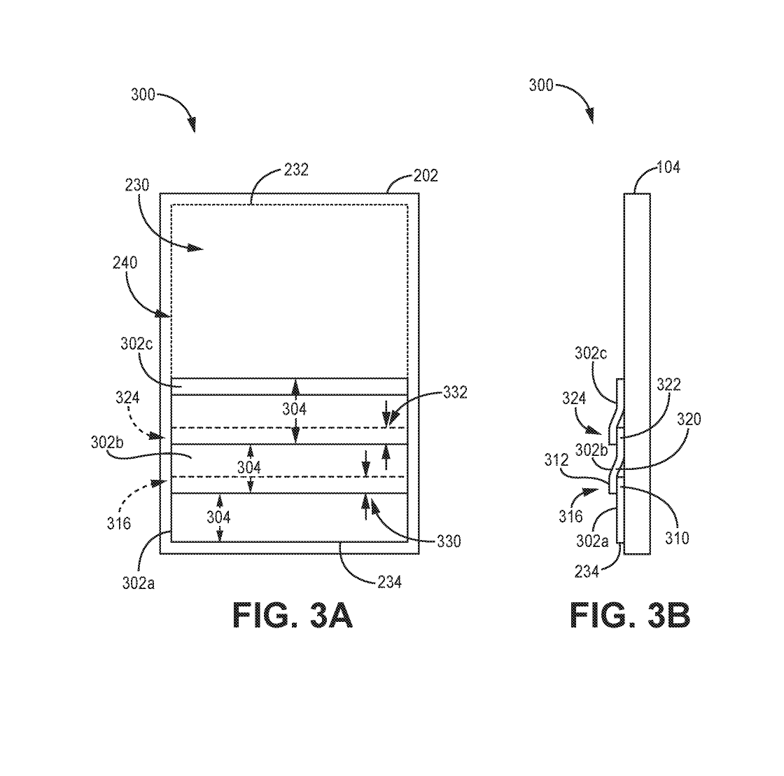

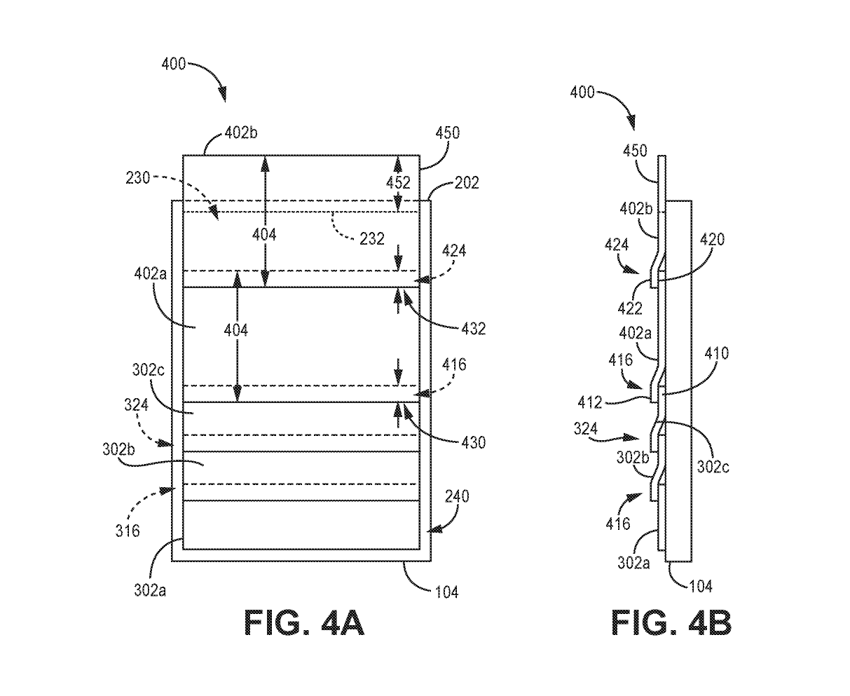

FIGS. 3A and 3B are plan and side schematic views, respectively, of a partially-masked pane 300 comprising the pane 104 after three pieces 302 of a masking material have been applied according to one possible embodiment. According to the illustrated embodiment, the masking pieces 302 have been cut from the masking roll 120 shown in FIG. 1, and thus have a width 304 that is smaller than pieces cut from the second roll 130 would have. As shown in FIGS. 3A and 3B, the masking pieces 302 cover a portion of the mask region 230 but not the entire mask region. As will be described in FIGS. 4A and 4B, additional pieces of masking material from the second masking roll 130 can be cut and applied to the remaining portion of the masking region 230.

It should be appreciated that the schematic views shown in the FIGS. are not drawn to scale, and in particular that the thickness of the masking material is exaggerated with respect to the glass pane 202 to aid in visualizing the embodiment.

Returning to FIGS. 3A and 3B, in this embodiment the masking pieces 302 are applied to the mask region 230 so that portions of two of the pieces 302a, 302b are covered by other pieces. For example, the masking piece 302a closest to the bottom edge 234 of the masking region includes a covered portion 310 that is covered by a covering portion 312 of the adjacent masking piece 302b. The extension of the covering portion 312 over the covered portion 310 creates a first covered region 316 in the masking material. The third masking piece 302c closest to the top edge 232 of the masking region also includes a covering portion 320 that extends over a covered portion 322 of the middle masking piece 302b. The coincidence of these two portions represents a second covered region 324.

Referring to FIG. 3A, the first and second covered regions 316, 324 are shown as having a first width 330 and a second width 332, respectively. According to some embodiments, the first and the second widths 330, 332 are the same. Thus, each covered region 316, 324 has the same width. While covered regions of equal width are not required, having an equal width can in some cases facilitate a masking procedure that is further standardized, which can lead to gains in efficiency.

The covered regions such as covered regions 316, 324 can also be referred to as overlap regions because the different pieces of masking material 302 overlap in the covered regions 316, 324. In some embodiments, the covered regions have a width 330, 332 of at least 1/32 inch (0.08 cm), 1/16 inch (0.16 cm), at least ⅛ inch (0.32 cm), at least ¼ inch (0.64 cm), at least ½ inch (1.27 cm) or at least 1 inch (2.5 cm). In some embodiment, the covered regions have a width of 330, 332 of at most four inches (10.2 cm), three inches (7.6 cm), two inches (5.1 cm), one inch (2.5 cm), ½ inch (1.27 cm) and ¼ inch (0.64 cm).

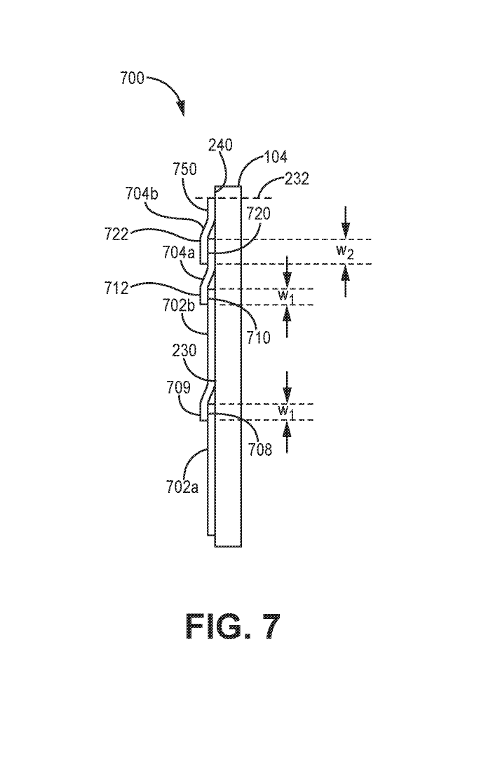

In some embodiments, the covered regions formed by adjacent pieces of masking material are not of equal width for a particular glass pane 104. In one embodiment, each of the covered regions formed by adjacent pieces for a particular glass pane 104 have different widths. In one embodiment, all except the last-formed covered region for a particular glass pane 104 has a uniform width, but the last-formed covered region has a different width. One example of this type of embodiment will be discussed with respect to FIG. 7.

The masking station 100 is configured to apply masking material to many glass units 104. In some embodiments, the masking station 100 is configured to apply masking material in a way to form a uniform width for covered regions. In some embodiments, widths of the covered regions vary based on the size of the mask region for a particular glass pane 104.

As will be further discussed in relation to FIG. 6, in some embodiments, the adjacent pieces of masking material do not overlap and instead touch at their adjacent edges. In one embodiment, the first piece of masking material has a first edge extending perpendicular to the first width and the second piece of masking material has a second edge perpendicular to the second width, and the first edge abuts the second edge along substantially an entire length of the first piece of masking material. Due to variations in the manufacturing process, in some embodiments, adjacent pieces of masking material would touch along a substantial portion of the length of their adjacent edges but not along the entire length of the adjacent edges. In some embodiments, the adjacent pieces of masking material do not touch, but instead are separated by a small gap.

In some embodiments where the masking pieces do not overlap, a gap-covering material can be used to cover the glass pane surface where adjacent masking pieces meet. The gap-covering material may bridge the gap between adjacent pieces of masking material and protect the glass pane surface in the gap. Examples of a gap-covering material include a spray-on material, a hot wax material, a temporary coating, or other gap-covering material. In some embodiments, the gap covering material is a polymeric masking material. In some embodiments, the gap covering material is the same as the masking material. In some embodiments, the gap-covering material would remain connected to the masking material pieces when the masking material pieces are removed from the glass surface, so that the gap-covering material would also be removed from the glass pane surface at the same time. In some embodiments, such a gap has a width of at most ½ inch (1.27 cm), ¼ inch (0.64 cm), ⅛ inch (0.32 cm) or 1/16 inch (0.16 cm).

FIGS. 4A and 4B are plan and side schematic views, respectively, of a masked pane 400 comprising the pane 104 after two pieces 402 of a masking material have been applied to the partially-masked pane 300 of FIGS. 3A and 3B, according to one possible embodiment. The pieces 402 have a second width 404 different from the first width 304 of the masking pieces 302. Following the application of the masking pieces 302 shown in FIGS. 3A & 3B, the pieces 402 are laid down on the glass pane 104 in order to further cover the masked region 230, so that masking material covers the surface of the glass unit 104 in the masked region 230 at least up to the top edge 232 of the masked region 230.

A piece 402a is applied to the masking region 230 of the glass pane 104 to overlap with one of the pieces 302c. The piece 402a overlaps with the piece 302c so that a covered portion 410 of piece 302c is covered by a covering portion 412 of the piece 402a in a covered or overlap region 416.

A second piece 402b is applied to the masking region 230 of the glass pane 104 to overlap with the first piece 402a of the masking material. The second piece 402b overlaps with the first piece 402a so that a covered portion 420 of first piece 402a is covered by a covering portion 424 of the second piece 402b in a covered or overlap region 424.

The covered region 416 has a width 430 and the covered region 424 has a width 432. According to some embodiments, the first and the second widths 430, 432 are the same. According to some embodiments, the first and the second widths 430, 432 are the same as first and second widths 330, 332 shown in FIG. 3A. Accordingly, in some embodiments each of the covered regions 316, 324, 416, 424 have the same width. While covered regions of equal width are not required, having an equal width can in some cases facilitate a masking procedure that is further standardized, which can lead to gains in efficiency.

After the second piece 402b is laid down, the masking region 230 is completely covered. In some embodiments, as in the example of FIGS. 4A and 4B, the final piece of masking material 402b also includes an extending portion 450 which extends beyond the top edge 232 of the masking region 230 and covers part or all of the perimeter nonmask region 240. The extending portion 450 has a width 452. The extending portion 450 is waste. The masking material will be cut at the location of the top edge 232 of the masking region 230 and the extending portion 450 will be removed. The system can include a removal tool configured to remove the extending portion of the second piece of masking material that is applied to the nonmask region.

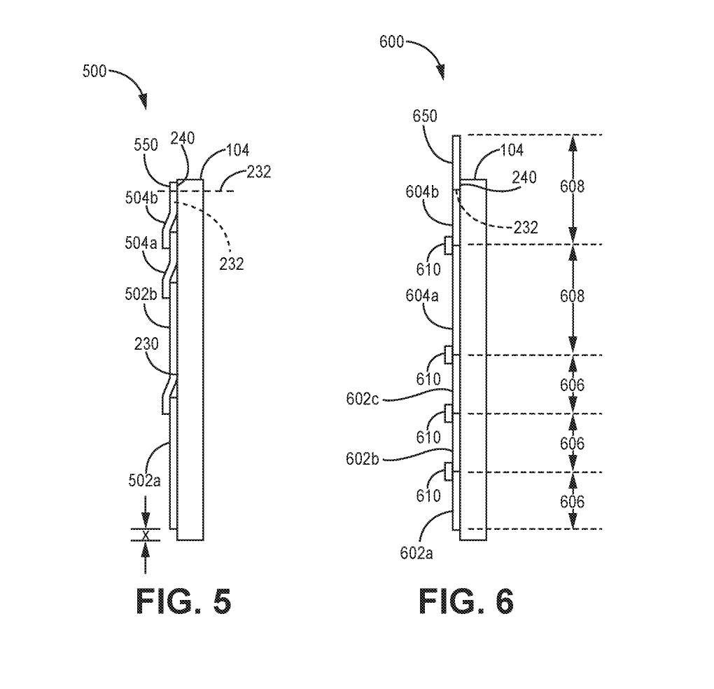

FIGS. 5 and 6 are side schematic views of masking material applied to panes according to additional embodiments. In the embodiment of FIG. 5, a glass unit 104 includes a mask region 230 and a perimeter nonmask region 240. The mask region 230 is covered by masking material made up of pieces 502a, 502b, which both have the same width, and pieces 504a, 504b, which both have the same width as each other but a different width than pieces 502a, 502b.

During the masking process in one embodiment, first, two pieces of masking material 502a, 502b are applied to the glass unit 104, with piece 502b slightly overlapping piece 502a. Then, piece 504a is laid down in a position to slightly overlap with piece 502b. Then piece 504b is laid down in a position to slightly overlap with piece 504a. Pieces 504a, 504b both have a first width. Pieces 502a, 502b both have a second width. The first width is smaller than the second width. After the piece 504b is laid down, the masking region 230 is completely covered up to and over the top edge 232 of the mask region 230. In the illustrated embodiment, the final piece of masking material 504b includes an extending portion 550 which extends beyond the top edge 232 of the masking region 230 and covers part, but not all, of the perimeter nonmask region 240. The extending portion 550 has a width and the extending portion 550 is waste. The masking material will be cut at the location of the top edge 232 of the masking region 230 and the extending portion 550 will be removed. The system can include a removal tool configured to remove the extending portion of the second piece of masking material that is applied to the nonmask region.

In the embodiment of FIG. 5, the wider pieces 502a, 502b are laid down first and the narrower pieces 504a, 504b are laid down next. In contrast, in the embodiment of FIGS. 4A and 4B, the narrower pieces are laid down first and the wider pieces are laid down next. In both the embodiment of FIG. 5 and the embodiment of FIGS. 4A and 4B, all the pieces of identical width are laid down before pieces of a different width are laid down.

In the embodiment of FIG. 6, three narrower masking pieces 602 are used and two wider masking pieces 604 are used in a masked glass unit 600 to cover the mask region 230 of the underlying glass unit 104. The narrower masking pieces 602 have a first width 606 while the wider masking pieces have a second width 608.

Unlike the previous embodiments illustrated in the FIGS., the masking pieces do not overlap in the embodiment of FIG. 6. Instead, the masking pieces are directly adjacent to each other along their lateral edges. As used herein, the term lateral edges refers to the edges of the masking pieces that are perpendicular to the width of the pieces, which are adjacent to lateral edges of other masking pieces.

In one embodiment, a gap-covering material 610 is present over the lateral edges of adjacent masking pieces.

FIG. 7 is a side schematic view of masking material applied to a pane according to additional embodiments. In the embodiment of FIG. 7, a glass unit 104 includes a mask region 230 and a perimeter nonmask region 240. The mask region 230 is covered by masking material made up of pieces 702a, 702b, which both have the same width, and pieces 704a, 704b, which both have the same width as each other but a different width than pieces 702a, 702b. In the embodiment of FIG. 7, the extent of overlap between the last two applied masking pieces 704a, 704b is sized so that there is no extending region of the masking material. As a result, there is no need to cut or trim the masking material.

In this embodiment the masking pieces 702, 704 are applied to the mask region 230 so that portions of some of the masking pieces 702, 704 are covered by other pieces, forming covered regions. For example, the masking piece 702a closest to the bottom edge of the masking region 230 includes a covered portion 708 that is covered by a covering portion 709 of the adjacent masking piece 702b. The extension of the covering portion 709 over the covered portion 708 creates a first covered region having a first width w₁ in the masking material. The third masking piece 704a of the masking region also includes a covering portion 712 that extends over a covered portion 710 of the second masking piece 702b. The coincidence of these two portions represents a second covered region. In the embodiment of FIG. 7, the second covered region also has the same first width w₁ in the masking material.

The fourth, and in this embodiment, final masking piece 704b of the masking region also includes a final covering portion 722 that extends over a final covered portion 720 of the masking piece 704a. The coincidence of these two portions represents a final covered region which has a width w₂ in the masking material. The width w₂ in the masking material is larger than the width w₁. The width w₂ is configured so that a top edge of the final masking piece 704b will align with the top edge 232 of the masking region. As a result, none of the final masking piece 704b is present on the perimeter nonmask region 240 and there is no need for trimming the final masking piece 704b.

Now referring to FIG. 1, the widths of the first masking roll and second masking roll can be selected to minimize the likely wasted masking material in light of the different sizes of glass panes that will be masked by the masking station 100. Another consideration in selecting the first and second widths is to minimize the number of passes over the glass panes during the process of masking the glass pane. In one embodiment of a window manufacturing environment, glass units 104 that are handled by a masking station 100 will have a maximum vertical dimension of 90 inches (228.6 cm) and a minimum vertical dimension of 14 inches (35.6 cm), and will have many different vertical dimensions in between. After considering the variety and distribution of likely vertical dimensions width of the masked areas of those various glass panes, the best widths for the first masking roll and second masking roll may be determined.

In various embodiments, the first masking roll has a width of at least two inches (5.1 cm), at least three inches (7.6 cm), at least four inches (10.1 cm), at least five inches (12.7 cm), at least six inches (15.2 cm) and at least seven inches (17.8 cm). In various embodiments, the first masking roll has a width of at most seven inches (17.8 cm), six inches (15.2 cm), five inches (12.7 cm), four inches (10.1 cm) and three inches (7.6 cm).

In various embodiments, the second masking roll has a width of at least six inches (15.2 cm), at least seven inches (17.8 cm), at least eight inches (20.3 cm), at least nine inches (22.9 cm), at least 10 inches (25.4 cm) and at least 12 inches (30.5 cm). In various embodiments, the second masking roll has a width of at most 15 inches (38.1 cm), at most 14 inches (35.6 cm), at most 13 inches (33.0 cm), at most 12 inches (30.5 cm), at most 11 inches (27.9 cm), at most 10 inches (25.4 cm) and at most nine inches (22.9 cm). In one embodiment, the first width is at least five inches (12.7 cm) less than the second width. In one embodiment, the first width is at least four inches (10.2 cm) less than the second width. In one embodiment, the first width is at least three inches (7.6 cm) less than the second width. In one embodiment, the first width is at least two inches (5.1 cm) less than the second width. In various embodiments, one of the first width and second width is an odd number of inches. In various embodiments, one of the first width and second width is an even number of inches and one is an odd number of inches. In one embodiment, at last one of the first width and the second width is a prime number of a unit of measurement.

In the embodiments described herein, two masking rolls having two different widths are used in a system to mask a glass unit. In another group of embodiments, three masking rolls are used having three different widths in a system to mask a glass unit. In another group of embodiments, four masking rolls are used having four different widths in a system to mask a glass unit.

A combination of two or more rolls having different widths can be used to form masking regions for a large variety of sizes of masking regions while minimizing the amount of waste masking material. The variety of sizes of masking regions to protect can be taken into when determining the appropriate widths for the two or more rolls. The masking material yield of a system for a given masked region width can be defined as a proportion of the masking region width to the width of the untrimmed masking material that is applied to the glass unit. An average masking material yield is an average of the yield for each masked region size that the system is configured to apply. In one embodiment, a system can have an average masking material yield of 90% or greater, 95% or greater, 98% or greater, or 99% or greater.

In addition to waste, another consideration is the number of passes by the movement mechanism that will be required to apply the masking material. A larger number of passes by the movement mechanism results in more time being required to apply the masking material.

Tables 1-3 shows how pieces from rolls of two different example widths can be combined to cover a variety of sizes of masking regions, resulting in a small amount of waste material being generated and therefore a high yield. The calculations of Tables 1-3 assume, for the sake of simplicity, that there is no overlap between adjacent pieces of the masking material. The widths of the various masking regions of Tables 1-3 vary by one inch (2.5 cm) increments from 17 inches (43.2 cm) to 48 inches (122.0 cm).

In one embodiment, the first masking roll has a width of 5 inches (12.7 cm) and the second masking roll has a width of 12 inches (30.5 cm). Table 1 summarizes possible combinations of these two masking roll widths. The combination of a five inch (12.7 cm) roll and a 12 inch (30.5 cm) roll provides an average yield of 99% for a system that is configured to apply masked regions as summarized in Table 1.

In one embodiment, the first masking roll has a width of six inches (15.2 cm) and the second masking roll has a width of 11 inches (27.9 cm). Table 2 summarizes possible combinations of these two masking roll widths. The combination of a six inch roll and a 12 inch (30.5 cm) roll provides an average yield of 98% for a system that is configured to apply masked regions as summarized in Table 2.

In one embodiment, the first masking roll has a width of seven inches (17.8 cm) and the second masking roll has a width of 10 inches (25.4 cm). Table 3 summarizes possible combinations of these two masking roll widths, which provides an average yield of 98% for a system that is configured to apply masked regions as summarized in Table 3.

The number of passes shown in Tables 1-3 for each masking region size equal the sum of the number of pieces from the first roll and the number of pieces from the second roll.

The example combinations of widths of masking material pieces shown in Tables 1-3 are not the only combination of widths possible for many of the masking region sizes. The combinations summarized in Tables 1-3 are optimized to minimize waste, but the combinations could be further adjusted to balance waste with cycle time. For example, for a masking region width of 35 inches (88.9 cm), Table 1 shows the use of 7 pieces of masking material from the first roll which has a width of five inches (12.7 cm). This results in seven passes being required. Alternatively, the system can be configured to apply three pieces of masking material from the second roll which has a width of 12 inches (30.5 cm). This application choice would result in an untrimmed masking material width of 36 inches (91.4 cm), a waste portion width of one inch (2.5 cm) and three passes.

TABLE 1
First Roll Width of 5 inches, Second Roll Width of 12 inches

| | No. of | No. of | Untrimmed | | | |
|---|---|---|---|---|---|---|
| Masked | Pieces | Pieces | Masking | Width of | | |
| Region | from | from | Material | Waste | | |
| Width | First | Second | Width | Portion | | No. of |
| (in/cm) | Roll | Roll | (in/cm) | (in/cm) | Yield | Passes |
| 17/43 | 1 | 1 | 17/43 | 0 | 100% | 2 |
| 18/46 | 4 | 0 | 20/51 | 2/5.1 | 89% | 4 |
| 19/48 | 4 | 0 | 20/51 | 1/2.5 | 95% | 4 |
| 20/51 | 4 | 0 | 20/51 | 0 | 100% | 4 |
| 21/53 | 2 | 1 | 22/56 | 1/2.5 | 95% | 3 |
| 22/56 | 2 | 1 | 22/56 | 0 | 100% | 3 |
| 23/58 | 0 | 2 | 24/61 | 1/2.5 | 96% | 2 |
| 24/61 | 0 | 2 | 24/61 | 0 | 100% | 2 |
| 25/64 | 5 | 0 | 25/64 | 0 | 100% | 5 |
| 26/66 | 3 | 1 | 27/69 | 1/2.5 | 96% | 4 |
| 27/69 | 3 | 1 | 27/69 | 0 | 100% | 4 |
| 28/71 | 1 | 2 | 29/74 | 1/2.5 | 96% | 3 |
| 29/74 | 1 | 2 | 29/74 | 0 | 100% | 3 |
| 30/76 | 6 | 0 | 30/76 | 0 | 100% | 6 |
| 31/79 | 4 | 1 | 32/81 | 1/2.5 | 97% | 5 |
| 32/81 | 4 | 1 | 32/81 | 0 | 100% | 5 |
| 33/84 | 2 | 2 | 34/86 | 1/2.5 | 97% | 4 |
| 34/86 | 2 | 2 | 34/86 | 0 | 100% | 4 |
| 35/89 | 7 | 0 | 35/89 | 0 | 100% | 7 |
| 36/91 | 0 | 3 | 36/91 | 0 | 100% | 3 |
| 37/94 | 5 | 1 | 37/94 | 0 | 100% | 6 |
| 38/97 | 3 | 2 | 39/99 | 1/2.5 | 97% | 5 |
| 39/99 | 3 | 2 | 39/99 | 0 | 100% | 5 |
| 40/102 | 8 | 0 | 40/102 | 0 | 100% | 8 |
| 41/104 | 1 | 3 | 41/104 | 0 | 100% | 4 |
| 42/107 | 6 | 1 | 42/107 | 0 | 100% | 7 |
| 43/109 | 4 | 2 | 44/112 | 1/2.5 | 98% | 6 |
| 44/112 | 4 | 2 | 44/112 | 0 | 100% | 6 |
| 45/114 | 9 | 0 | 45/114 | 0 | 100% | 9 |
| 46/117 | 2 | 3 | 46/117 | 0 | 100% | 5 |
| 47/119 | 7 | 1 | 47/119 | 0 | 100% | 8 |
| 48/122 | 0 | 4 | 48/122 | 0 | 100% | 4 |

| | |
|---|---|
| Average Yield | 99% |

TABLE 2
First Roll Width of 6 inches, Second Roll Width of 11 inches

| | No. of | No. of | Untrimmed | | | |
|---|---|---|---|---|---|---|
| Masked | Pieces | Pieces | Masking | Width of | | |
| Region | from | from | Material | Waste | | |
| Width | First | Second | Width | Portion | | No. of |
| (in/cm) | Roll | Roll | (in/cm) | (in/cm) | Yield | Passes |
| 17/43 | 1 | 1 | 17/43 | 0 | 100% | 2 |
| 18/46 | 3 | 0 | 18/46 | 0 | 100% | 3 |
| 19/48 | 0 | 2 | 22/56 | 3/7.6 | 84% | 2 |
| 20/51 | 0 | 2 | 22/56 | 2/5.1 | 90% | 2 |
| 21/53 | 0 | 2 | 22/56 | 1/2.5 | 95% | 2 |
| 22/56 | 0 | 2 | 22/56 | 0 | 100% | 2 |
| 23/58 | 2 | 1 | 23/58 | 0 | 100% | 3 |
| 24/61 | 4 | 0 | 24/61 | 0 | 100% | 4 |
| 25/64 | 1 | 2 | 28/71 | 3/7.6 | 88% | 3 |
| 26/66 | 1 | 2 | 28/71 | 2/5.1 | 92% | 3 |
| 27/69 | 1 | 2 | 28/71 | 1/2.5 | 96% | 3 |
| 28/71 | 1 | 2 | 28/71 | 0 | 100% | 3 |
| 29/74 | 3 | 1 | 29/74 | 0 | 100% | 4 |
| 30/76 | 5 | 0 | 30/76 | 0 | 100% | 5 |
| 31/79 | 0 | 3 | 33/84 | 2/5.1 | 94% | 3 |
| 32/81 | 0 | 3 | 33/84 | 1/2.5 | 97% | 3 |
| 33/84 | 0 | 3 | 33/84 | 0 | 100% | 3 |
| 34/86 | 2 | 2 | 34/86 | 0 | 100% | 4 |
| 35/89 | 4 | 1 | 35/89 | 0 | 100% | 5 |
| 36/91 | 6 | 0 | 36/91 | 0 | 100% | 6 |
| 37/94 | 1 | 3 | 39/99 | 2/5.1 | 95% | 4 |
| 38/97 | 1 | 3 | 39/99 | 1/2.5 | 97% | 4 |
| 39/99 | 1 | 3 | 39/99 | 0 | 100% | 4 |
| 40/102 | 3 | 2 | 40/102 | 0 | 100% | 5 |
| 41/104 | 5 | 1 | 41/104 | 0 | 100% | 6 |
| 42/107 | 7 | 0 | 42/107 | 0 | 100% | 7 |
| 43/109 | 0 | 4 | 44/112 | 1/2.5 | 98% | 4 |
| 44/112 | 0 | 4 | 44/112 | 0 | 100% | 4 |
| 45/114 | 2 | 3 | 45/114 | 0 | 100% | 5 |
| 46/117 | 4 | 2 | 46/117 | 0 | 100% | 6 |
| 47/119 | 6 | 1 | 47/119 | 0 | 100% | 7 |
| 48/122 | 8 | 0 | 48/122 | 0 | 100% | 8 |

| | |
|---|---|
| Average Yield | 98% |

TABLE 3
First Roll Width of 7 inches, Second Roll Width of 10 inches

| | No. of | No. of | Untrimmed | | | |
|---|---|---|---|---|---|---|
| Masked | Pieces | Pieces | Masking | Width of | | |
| Region | from | from | Material | Waste | | |
| Width | First | Second | Width | Portion | | No. of |
| (in/cm) | Roll | Roll | (in/cm) | (in/cm) | Yield | Passes |
| 17/43 | 1 | 1 | 17/43 | 0 | 100% | 2 |
| 18/46 | 0 | 2 | 20/51 | 2/5.1 | 89% | 2 |
| 19/48 | 0 | 2 | 20/51 | 1/2.5 | 95% | 2 |
| 20/51 | 0 | 2 | 20/51 | 0 | 100% | 2 |
| 21/53 | 3 | 0 | 21/53 | 0 | 100% | 3 |
| 22/56 | 2 | 1 | 24/61 | 2/5.1 | 91% | 3 |
| 23/58 | 2 | 1 | 24/61 | 1/2.5 | 96% | 3 |
| 24/61 | 2 | 1 | 24/61 | 0 | 100% | 3 |
| 25/64 | 1 | 2 | 27/69 | 2/5.1 | 92% | 3 |
| 26/66 | 1 | 2 | 27/69 | 1/2.5 | 96% | 3 |
| 27/69 | 1 | 2 | 27/69 | 0 | 100% | 3 |
| 28/71 | 4 | 0 | 28/71 | 0 | 100% | 4 |
| 29/74 | 0 | 3 | 30/76 | 1/2.5 | 97% | 3 |
| 30/76 | 0 | 3 | 30/76 | 0 | 100% | 3 |
| 31/79 | 3 | 1 | 31/79 | 0 | 100% | 4 |
| 32/81 | 2 | 2 | 34/86 | 2/5.1 | 94% | 4 |
| 33/84 | 2 | 2 | 34/86 | 1/2.5 | 97% | 4 |
| 34/86 | 2 | 2 | 34/86 | 0 | 100% | 4 |
| 35/89 | 5 | 0 | 35/89 | 0 | 100% | 5 |
| 36/91 | 1 | 3 | 37/94 | 1/2.5 | 97% | 4 |
| 37/94 | 1 | 3 | 37/94 | 0 | 100% | 4 |
| 38/97 | 4 | 1 | 38/97 | 0 | 100% | 5 |
| 39/99 | 0 | 4 | 40/102 | 1/2.5 | 97% | 4 |
| 40/102 | 0 | 4 | 40/102 | 0 | 100% | 4 |
| 41/104 | 3 | 2 | 41/104 | 0 | 100% | 5 |
| 42/107 | 6 | 0 | 42/107 | 0 | 100% | 6 |
| 43/109 | 2 | 3 | 44/112 | 1/2.5 | 98% | 5 |
| 44/112 | 2 | 3 | 44/112 | 0 | 100% | 5 |
| 45/114 | 5 | 1 | 45/114 | 0 | 100% | 6 |
| 46/117 | 1 | 4 | 47/119 | 1/2.5 | 98% | 5 |
| 47/119 | 1 | 4 | 47/119 | 0 | 100% | 5 |
| 48/122 | 4 | 2 | 48/122 | 0 | 100% | 6 |

| | |
|---|---|
| Average Yield | 98% |

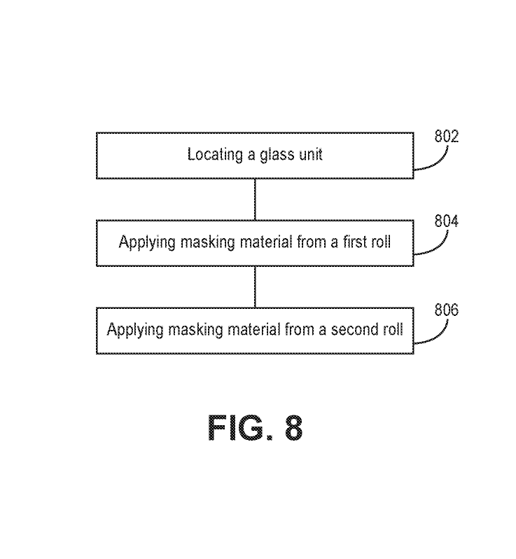

FIG. 8 is a flow diagram illustrating a method of masking glass pane according to an embodiment. In this example, the masking method 800 includes at least locating 802 a glass pane, which may be part of a glass unit having one or more glass panes. The method 800 also includes applying 804 a masking material to the glass pane from a first roll of masking material and applying 806 a masking material to the glass pane from a second roll of masking material.

According to some embodiments, locating 802 the glass pane generally refers to positioning the glass pane in a known location and/or determining the location of the glass pane, such as its position relative to other equipment, tools, and reference points. For example, a method may include moving (e.g., by hand or by machine) the glass pane to a known location upon a masking workstation. Such movement may be part of a larger process of manufacturing glass panes. As a glass pane is moved from one workstation to a masking workstation, for example, the glass pane may be automatically placed in a pre-determined location at the masking workstation. As another example, locating the glass pane may include determining the relative position of a glass pane already supported by a masking workstation. Locating the glass pane in these and other manners can be useful for aligning or registering masking equipment with the glass pane.

According to some embodiments, applying masking material from the first and/or second rolls of masking material includes applying one or more pieces of masking material to a surface of a glass pane. As an example, a masking method could involve applying the three pieces 302 of masking material shown in FIGS. 3A and 3B from the first masking roll 120 shown in FIG. 1.

According to some embodiments, the width of masking material applied from the first masking roll has a width that is different from the width of masking material applied from the second masking roll. FIGS. 4A and 4B, for example, show that the pieces 402 of masking material applied from the second masking roll 130 in FIG. 1 have a different width 404 from the width 304 of the pieces 302 applied from the first masking roll 120.

According to some embodiments, masking a pane may include applying multiple pieces of masking material to a surface of a glass pane. In some cases all of the pieces of masking material that are applied to the glass pane's surface have one of two possible widths. For example, the embodiment shown in FIGS. 4A and 4B includes the first pieces 302 of masking material, all of which have the first width 304, and the second pieces 402 of masking material, all of which have the second width 404.

Embodiments of the invention are not limited to masking pieces of only two widths. In some cases, a method of masking a pane may include applying masking pieces of two, three, four, or more different widths. For example, in some embodiments a masking station may optimize the masking of a glass pane by applying three or more pieces of masking material, each having one of three or more different widths. In some cases using a combination of masking pieces with multiple widths can assist in reducing the amount of waste material that may need to be trimmed from the masking material.

As discussed above with respect to FIG. 2, in some embodiments a surface of a glass pane has a mask region and a nonmask region. In these types of embodiments, a masking method can include applying at least a first piece of masking material from the first roll to the mask region and also applying at least a second piece of masking material from the second masking roll to the mask region. As shown in FIGS. 4A and 4B, in some cases a masking method also includes applying an extending portion 450 of the second piece of masking material to the nonmask region. In some cases the extending portion of the second piece of masking material has a width that is no greater than about 2 inches (5.1 cm). As an example, in some embodiments the width of the extending portion may be about ⅛ inch (0.3 cm) to about 2 inches (5.1 cm). Methods of masking involving an extending portion covering the nonmask region may also include removing the extending portion of masking material overlying the nonmask region.

According to some embodiments, as discussed above with respect to FIGS. 3A-7, masking a glass pane can sometimes include covering or overlapping a covered portion of a first piece of masking material with a covering portion of a second piece of masking material. Such portions of a mask can be referred to as overlapping regions or covered regions. According to some embodiments of the invention, methods of masking a pane include applying pieces of masking material in an adjacent manner on the glass pane such that adjacent pieces of masking material produce an overlap or covered region. In some cases, the covered regions between all adjacent masking pieces have the same width.

Thus, embodiments of the invention are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention and the scope of the appended claims.

What is claimed is:

1. A method of masking a glass pane, comprising:
locating a planar substrate;
applying a first piece of masking material to a first surface of the planar substrate; and
applying a second piece of masking material to the first surface of the planar substrate;
wherein the first piece of masking material has a first width and the second piece of masking material has a second width different than the first width.

2. The method of claim 1, wherein the first surface of the planar substrate comprises a mask region and a nonmask region, and wherein applying the first and the second pieces of masking material to the first surface comprises applying the first and the second pieces of masking material to the mask region.

3. The method of claim 2, further comprising:
applying an extending portion of the second piece of masking material to the nonmask region.
removing the extending portion of the second piece of masking material overlying the nonmask region.

4. The method of claim 1, further comprising applying a third piece of masking material to the first surface of the planar substrate, wherein the third piece has a third width that is equal to one of the first width or the second width.

5. The method of claim 1, further comprising applying a plurality of pieces of masking material to the first surface of the planar substrate, wherein the plurality of pieces includes all pieces of masking material that are applied to the first surface, and wherein all of the plurality of pieces of masking material have the first width or the second width.

6. The method of claim 1, further comprising covering a portion of the first piece of masking material with a covering portion of the second piece of masking material to define a covered portion of the first piece of masking material.

7. The method of claim 1, wherein the first piece of masking material abuts and does not overlap the second piece of masking material.

8. The method of claim 7, further applying a gap-covering material of an edge of the first piece of masking material and an adjacent edge of the second piece of masking material.

9. The method of claim 1, wherein the planar substrate comprises a glass pane.

10. A masked planar substrate, comprising:
a planar substrate having a surface comprising an inner mask region and a perimeter nonmask region surrounding the mask region; and
a mask covering the mask region of the surface but not the nonmask region of the surface, the mask comprising a plurality of pieces of a masking material, comprising a first piece of masking material having a first width and a second piece of masking material having a second width different than the first width.

11. The masked planar substrate of claim 10, wherein the first piece of masking material does not cover any portion of the second piece of masking material and the second piece of masking material does not cover any portion of the first piece of masking material.

12. The masked planar substrate of claim 11, wherein the first piece of masking material has a first edge extending perpendicular to the first width and the second piece of masking material has a second edge perpendicular to the second width, and wherein the first edge abuts the second edge along substantially an entire length of the first piece of masking material.

13. The masked planar substrate of claim 10, wherein the mask comprises a first covered region comprising a covered portion of the first piece and a covering portion of the second piece that covers the covered portion of the first piece.

14. The masked planar substrate of claim 10, wherein the first width is between about 2 inches (5.1 cm) and about 16 inches (40.6 cm) and the second width is between about 1 inch (2.5 cm) and about 10 inches (25.4 cm).

15. The masked planar substrate of claim 10, wherein the planar substrate comprises a glass pane.

16. A system for masking a glass unit, comprising:
a workstation configured to support a planar substrate having a first surface;
a first roll of masking material having a first width;
a second roll of masking material having a second width different than the first width;
a movement mechanism configured to move the first roll and the second roll relative to the planar substrate; and
an applicator configured to apply pieces of masking material from the first roll and pieces of masking material from the second roll to the first surface of the planar substrate.

17. The system of claim 16, wherein the surface of the planar substrate comprises a mask region and a nonmask region, and wherein the applicator is configured to apply the first piece of masking material to the mask region and is further configured to apply the second piece of masking material, but not the first piece of masking material, to both the mask region and the nonmask region.

18. The system of claim 17, wherein the applicator is configured to apply an extending portion of the second piece of masking material to the nonmask region.

19. The system of claim 18, further comprising a removal tool configured to remove the extending portion of the second piece of masking material that is applied to the nonmask region.

20. The system of claim 16, wherein the planar substrate comprises a glass pane.
